(19) United States
(12) Patent Application Publication
(10) Pub. No.: US 2007/0219792 A1
(43) Pub. Date: Sep. 20, 2007

(54) Method and system for user authentication based on speech recognition and knowledge questions

(75) Inventor: Yves Normandin, St-Hubert (CA)

Correspondence Address: KOLISCH HARTWELL, P.C., 200 PACIFIC BUILDING, 520 SW YAMHILL STREET, PORTLAND, OR, 97204, US

(73) Assignee: NU ECHO INC.

(21) Appl. No.: 11/385,228

(22) Filed: Mar. 20, 2006

(51) Int. Cl. G10L 15/00

(52) U.S. Cl. 704/239

(57) ABSTRACT

A method and system for user authentication based on speech recognition and knowledge questions. The method comprises receiving a speech recognition result derived from ASR processing of a received utterance. A reference information element is obtained for the utterance. Then, the method determines at least one similarity metric indicative of a degree of similarity between the speech recognition result and the reference information element. A feature vector is determined from the at least one similarity metric, and a score is computed based on the elements of the feature vector. A classifier may be used to process the elements of the feature vector, with the classifier having been trained to tend to produce higher scores when processing training feature vectors derived from utterances known to convey associated reference information elements than when processing training feature vectors derived from utterances known not to convey said associated reference information elements.

### FIELD OF THE INVENTION

The present invention relates generally to user authentication and, in particular, to a method and a system for automating user authentication by employing speech recognition and knowledge questions.

### BACKGROUND

User authentication is required in applications such as telephone banking, among others. Typically, a user (e.g., a legitimate customer of a bank, or an impostor thereof) begins by identifying herself to a telephone operator by providing basic information such as a customer name or account number. The operator accesses a customer record corresponding to the basic information provided, and then elicits from the user additional information that is stored in the customer record and that would allow the user to be authenticated, thus proving to a satisfactory degree that the user is indeed who she says she is. Examples of such additional information include a postal (zip) code, a date, a name, a PIN, etc., that is certain to be known by a legitimate user (unless forgotten) but unlikely to be known by an impostor. The additional information may be elicited by asking the user to answer a so-called knowledge question, such as “What is your mother's maiden name?” (or the equivalent knowledge directive, “Please state your mother's maiden name.”) To authenticate the user, the operator compares the user's answer against the expected answer stored in the customer record and makes a decision to either grant or deny the user access to an account or other facility.

Clearly, there are costs involved in hiring human operators to perform the previously described authentication process. With the advent of automatic speech recognition (ASR) engines, interactive voice response systems have been developed that can assist in performing all or part of the authentication process, thereby reducing labor costs associated with human operators. Such systems can be referred to as automatic speech recognition-based authentication systems, hereinafter referred to as ASR-based authentication systems for short.

However, ASR-based authentication systems are not perfect. Specifically, it may happen that the user utters the expected answer to a knowledge question, but is nevertheless declared as not authenticated. This occurrence is known as a “false rejection” which, in a telephone banking scenario, would undesirably result in a legitimate customer being denied access to her account. The converse problem (i.e., a “false acceptance”) may also occur, namely when an impostor who poses as a legitimate customer by providing that customer's name or account number is declared as authenticated despite not having uttered the expected answer to a knowledge question intended for the customer in question. This effect is also undesirable, as it would allow an impostor to gain illicit access to a legitimate customer's account.

Thus, when an institution such as a bank considers selecting an ASR-based authentication system to be used in applications such as telephone banking, attention needs to be paid to the system's “performance”, which is typically judged on the basis of a curve that plots the rate of false rejection versus the rate of false acceptance, for a given sample set. Thus, before gaining widespread acceptance, ASR-based authentication systems need to meet the key performance goal of bringing the false acceptance rate and the false rejection rate to an acceptably low level.

In the context of ASR-based authentication, conventional approaches have tended to frame the authentication problem as a comparison between one (or sometimes more than one) recognition hypothesis (derived from a user's utterance) with the expected answer to a knowledge question. Specifically, when there is a “match” between the recognition hypothesis and the expected answer to the knowledge question, the user is declared to be authenticated. Conversely, when there is no match, the user is declared to be not authenticated.

As a consequence of the foregoing, conventional ASR-based authentication systems will produce a false rejection when the output of the ASR engine does not include among its recognition hypotheses the expected answer to the knowledge question, despite the user actually having uttered the expected answer to the knowledge question. Stated differently, erroneous performance of the ASR engine can cause the ASR-based authentication system to declare that the user is not authenticated when in fact she should have been. It follows that the rate of false rejection of a conventional ASR-based authentication system is intimately tied to the performance of the ASR engine, i.e., the better the ASR engine, the better the performance of a conventional ASR-based authentication system.

Unfortunately, there is a natural limit on the accuracy and precision of an ASR engine, which can be affected by the type of “grammar” used by the ASR engine as well as the acoustic similarity between various sets of letters or words. As a result, the rate of false rejection of conventional ASR-based authentication systems remains at a level that may be unacceptably high to achieve widescale public acceptance in applications such as telephone banking.

### SUMMARY OF THE INVENTION

Using a fundamentally different approach, the present invention frames the authentication problem as a decision that reflects whether the user is deemed to have uttered the expected answer to a knowledge question. To achieve superior performance, the ASR-based authentication system of the present invention takes into account the possibility that certain errors may have been committed by the ASR engine. Therefore, as a result of the techniques disclosed herein, the rate of false rejection can be reduced to an acceptably low level.

Accordingly, a first broad aspect of the present invention seeks to provide a method, which comprises: receiving a speech recognition result derived from ASR processing of a received utterance; obtaining a reference information element for the utterance; determining at least one similarity metric indicative of a degree of similarity between the speech recognition result and the reference information element; determining a score based on the at least one similarity metric; and outputting a data element indicative of the score.

A second broad aspect of the present invention seeks to provide a score computation engine for use in user authentication. The score computation engine comprises a feature extractor operable to determine at least one similarity metric indicative of a degree of similarity between (i) a speech recognition result derived from ASR processing of a received utterance; and (ii) a reference information element for the utterance; and a classifier operable to determine a score based on the at least one similarity metric and to output a data element indicative of the score.

A third broad aspect of the present invention seeks to provide an authentication method, which comprises: receiving from a party a purported identity of a user, the user being associated with a knowledge question and a corresponding stored response to the knowledge question; providing to the caller an opportunity to respond to the knowledge question associated with the user; receiving from the caller a first utterance responsive to the providing, the first utterance corresponding to the knowledge question associated with the user; providing to the caller a second opportunity to respond to the knowledge question associated with the user; receiving from the caller a plurality of second utterances responsive to the providing, each of the plurality of second utterances corresponding to an alphanumeric character corresponding to the knowledge question associated with the user; determining a score indicative of a similarity between the plurality of second utterances and the stored response to the knowledge question associated with the user; and declaring the party as either authenticated or not authenticated on the basis of the score.

The invention may be embodied in a processor readable medium containing a software program comprising instructions for a processor to implement any of the above described methods.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a functional block diagram of an ASR-based authentication system in accordance with a non-limiting embodiment of the present invention, the system comprising an ASR engine.

FIG. 2 is a flow diagram illustrating the flow of data elements between various functional components of the ASR-based authentication system, in accordance with a non-limiting embodiment of the present invention.

FIG. 3 is a combination block diagram/flow diagram illustrating a training phase used in the ASR-based authentication system, in accordance with a non-limiting embodiment of the present invention.

FIG. 4 is a variant of FIG. 1 for the case where the grammar used by the ASR engine is dynamically built.

FIG. 5 is a variant of FIG. 2 for the case where the grammar used by the ASR engine is dynamically built.

FIGS. 6A and 6B together depict a variant of FIG. 3 for the case where the grammar used by the ASR engine is dynamically built.

### DETAILED DESCRIPTION OF EMBODIMENTS

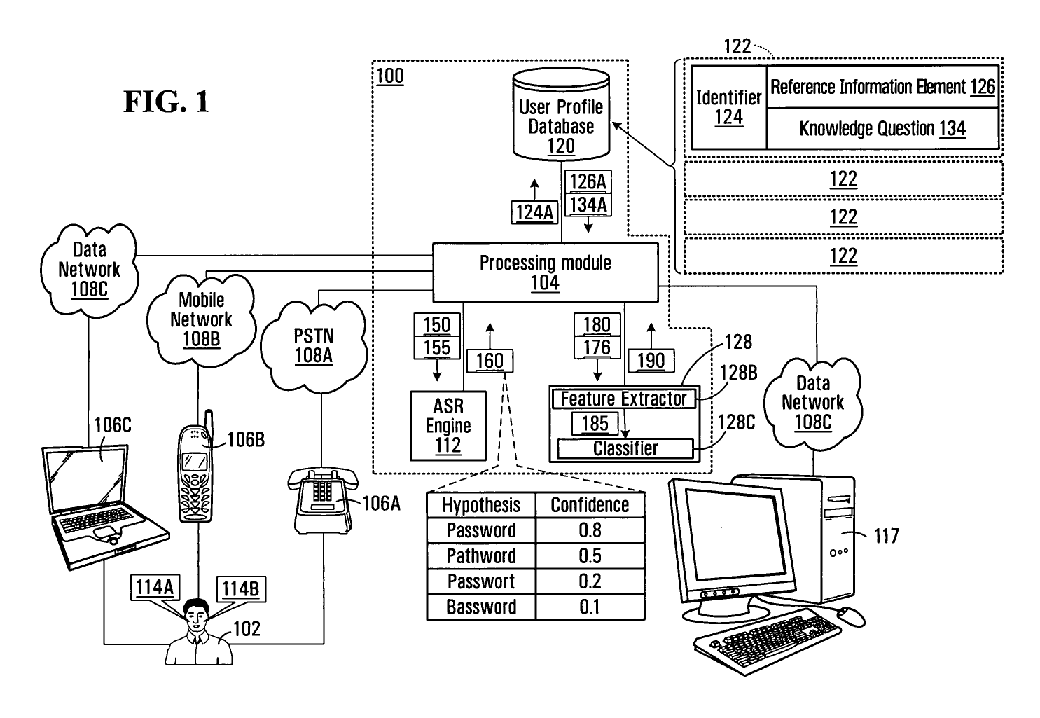

FIG. 1 shows an ASR-based authentication system 100 in accordance with a specific non-limiting example embodiment of the present invention. The system 100 comprises a processing module 104, an automatic speech recognition (ASR) engine 112, a user profile database 120 and a score computation engine 128. As shown in FIG. 1, a caller 102 may reach the system 100 using a conventional telephone 106A connected over the public switched telephone network (PSTN) 108A. Alternatively, the caller 102 may use a mobile phone 106B connected over a mobile network 108B, or a packet data device 106C (such as a VoIP phone, a computer or a networked personal digital assistant) connected over a data network 108C. Still other variants are possible and such variants are within the scope of the present invention.

The processing module 104 comprises suitable circuitry, software and/or control logic for interacting with the caller 102 by, e.g., capturing keyed sequences of digits and verbal utterances emitted by the caller 102 (such as utterance 114A, 114B in FIG. 1), as well as generating audible prompts and sending them the caller 102 over the appropriate network. It should be noted that the utterance 114A may represent an identity claim made by the caller 102, while the utterance 114B may represent additional information required for authentication of the caller 102 who claims to be a legitimate user of the system 100.

The processing module 104 supplies the ASR engine 112 with an utterance data element 150 and a grammar data element 155. The utterance data element 150 may comprise an utterance, such as the utterance 114A or the utterance 114B, on which speech recognition is to be performed by the ASR engine 112. The grammar data element 155 may comprise or identify a “grammar”, which can be defined as a set of possible sequences of letters and/or words that the ASR engine 112 is capable of recognizing. Other definitions exist and will be known to those skilled in the art. In the non-limiting embodiment being presently described, the grammar comprised or identified in the grammar data element 155 is fixed for all legitimate users of the system 100. An embodiment where this is not the case will be described later on.

The ASR engine 112 comprises suitable circuitry, software and/or control logic for executing a speech recognition process based on the utterance data element 150 received from the processing module 104. The ASR engine 112 generates a speech recognition data element 160 containing a set of N speech recognition hypotheses. Usually, N is greater than or equal to 1, with each speech recognition hypothesis constrained to being in the grammar identified in the grammar data element 155. Each of the N speech recognition hypotheses in the speech recognition data element 160 represents a sequence of letters and/or words that the ASR engine 112 believes may have been uttered by the caller 102. Each of the N speech recognition hypotheses in the speech recognition data element 160 may further be accompanied by a confidence score (e.g., between 0 and 1), which indicates how confident the ASR engine 112 is that the given speech recognition hypothesis corresponds to the sequence of letters and/or words that was actually uttered by the caller 102.

In some cases, N could actually be zero. This is called a “no-match”, and occurs when the ASR engine 112 cannot find anything in the grammar that resembles the utterance data element 150. The occurrence of a no-match may result if, for example, someone coughs or says something very different from anything in the grammar.

Among the N speech recognition hypotheses, no more than a single one of these is usually correct (i.e., corresponds to the sequence of letters and/or words actually uttered by the caller 102). However, it may sometimes happen that multiple speech recognition hypotheses with the same semantic interpretation will be among the N speech recognition hypotheses. It could also happen that none of the N speech recognition hypotheses is correct, meaning that the sequence of letters and/or words actually uttered by the caller 102 does not correspond to any of the N speech recognition hypotheses. The ASR engine 112 returns the speech recognition data element 160 containing the set of N speech recognition hypotheses to the processing module 104.

Continuing with the description of FIG. 1, the user profile database 120 stores a plurality of records 122 associated with respective legitimate users of the system 100. Specifically, a particular legitimate user can be associated with a particular one of the records 122 that is indexed by a user identifier (or “userid”) 124 and having at least one associated reference information element 126. The userid 124 that indexes a particular one of the records 122 serves to identify the particular legitimate user (e.g., by way of a name and address, or account number) with which the particular one of the records 122 is associated, while the presence of the at least one reference information element 126 in the particular one of the records 122 represents additional information used to authenticate the particular legitimate user.

For the sake of simplicity, in the specific non-limiting embodiment of the present invention to be described herein below, the reference information element 126 in a particular one of the records 122 represents the correct answer to a knowledge question. Nevertheless, it is within the scope of the present invention for the reference information element 126 (or a plurality of reference information elements) in a particular one of the records 122 to represent correct answers to a multiplicity of knowledge questions.

In addition, a particular one of the records 122 that is associated with a particular legitimate user may include a third field 134 that stores the knowledge question to which the answer is represented by the reference information element 126 in the particular one of the records 122, thereby to allow the knowledge question (and its answer) to be customized by the particular legitimate user. This third field 134 is not required when the knowledge question is known a priori or is not explicitly used (such as when the reference information element 126 in the particular one of the records 122 is a personal identification number—PIN).

The processing module 104 further comprises suitable circuitry, software and/or control logic for interacting with the user profile database 120. Specifically, the processing module 104 queries the user profile database 120 with a candidate userid 124A. In response, the user profile database 120 will return a reference information element 126A, which can be the reference information element 126 in the particular one of the records 122 indexed by the candidate userid 124A. In addition, in this embodiment, the user profile database 120 returns a selected knowledge question 134A, which is the content of the third field 134 in the particular one of the records 122 indexed by the candidate userid 124A.

It is assumed that once authenticated, a particular legitimate user of the system 100 may be allowed to access a resource associated with that user, such as a bank account, a cellular phone account, credit privileges, etc. Thus, it may be desirable that the reference information element 126 in the particular one of the records 122 associated with the particular legitimate user be known to the particular legitimate user but unknown to other parties, including impostors such as, potentially, the caller 102. Accordingly, in an example, the reference information element 126 in the particular one of the records 122 associated with the particular legitimate user could specify the particular legitimate user's mother's maiden name, date of birth, favorite color, etc., depending on the nature of the knowledge question which, it is recalled, can be stored in the third field 134 of the particular one of the records 122 associated with the particular legitimate user.

It should be appreciated that in certain embodiments, it may be desirable to allow the particular legitimate user to configure the contents of the associated one of the records 122 in the database 120. Specifically, the particular legitimate user could be allowed to change the reference information element 126 in the particular one of the records 122 associated with the particular legitimate user and/or the knowledge question stored in the third field 134 in the particular one of the records 122 associated with the particular legitimate user. Accordingly, as shown in FIG. 1, the processing module 104 may be directly reachable by the particular legitimate user by means of a computing device 117 connected to the data network 108C (e.g., the Internet). Alternatively, the processing module 104 may be accessed by a human operator who interacts with the particular legitimate user via the PSTN 108A or the mobile network 108B, thus allowing changes in the associated one of the records 122 to be effected via telephone.

Continuing with the description of FIG. 1, the processing module 104 supplies the score computation engine 128 with a speech recognition data element 180 and a reference information element 176. In an example, the speech recognition data element 180 may comprise the aforementioned speech recognition data element 160 output by the ASR engine 112, which may contain N speech recognition hypotheses. For its part, the reference information element 176 may comprise the reference information element 126A received from the user profile database 120. The score computation engine 128 comprises suitable circuitry, software and/or control logic for executing a score computation process based on the speech recognition data element 180 and the reference information element 176, thereby to produce a score 190, which is returned to the processing module 104. Further details regarding the score computation process will be provided later on.

Additionally, the processing module 104 comprises suitable circuitry, software and/or control logic for processing the score 190 to declare the caller 102 as having been (or not having been) successfully authenticated as a legitimate user of the system 100.

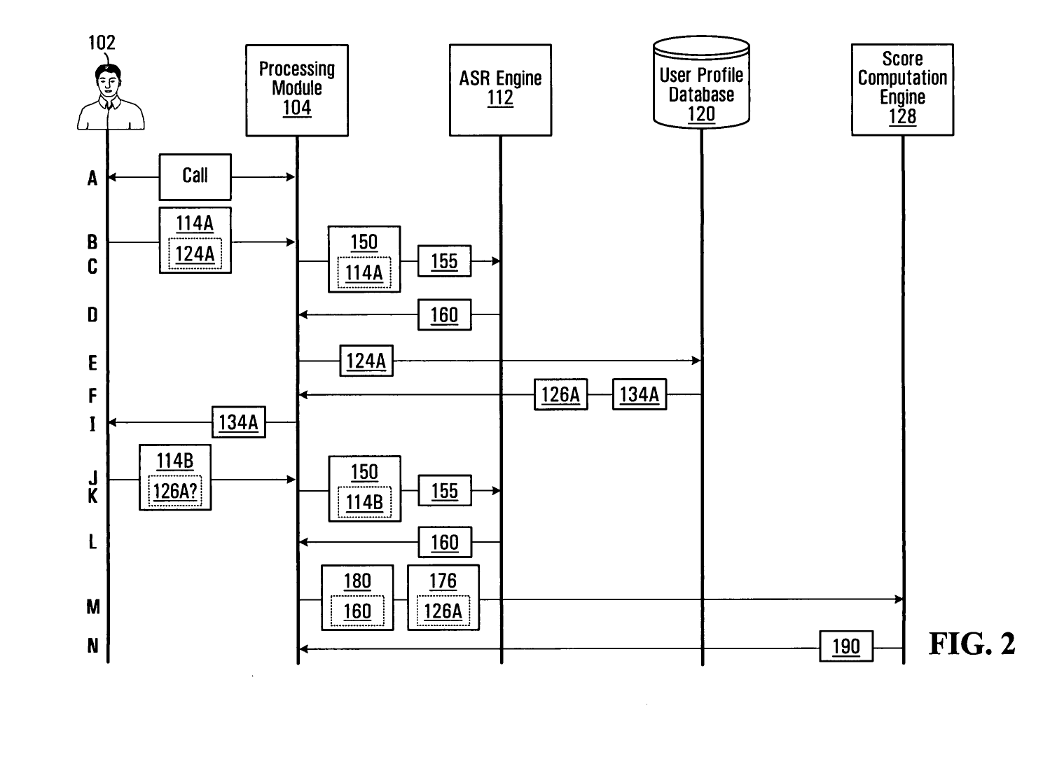

Having described the basic functional components of the ASR-based authentication system 100 and the input/output relationship among these components, further detail about their operation is now provided with reference to the flow diagram shown in FIG. 2. Specifically, at flow A, the caller 102 accesses the processing module 104, e.g., by placing a call to a telephone number associated with the system 100. The processing module 104 answers the call and requests the caller 102 to make an identity claim. The caller 102 makes an identity claim by either keying in or uttering a name and/or address and/or number associated with a legitimate user. With the understanding that a sequence of utterances or entries may be required before an identity claim is considered to have been made, assume for the sake of simplicity that caller 102 makes a first utterance 114A containing an identity claim that is representative of the candidate userid 124A. At flow B, the first utterance 114A is sent to the processing module 104. The processing module 104 captures the first utterance 114A and, at flow C, sends the utterance data element 150 (containing the first utterance 114A) and the grammar data element 155 to the ASR engine 112 for processing.

At flow D, the ASR engine 112 returns the speech recognition data element 160 to the processing module 104. In a specific non-limiting embodiment, the speech recognition data element 160 comprises a set of N speech recognition hypotheses with associated confidence scores. Each of the N speech recognition hypotheses represents a userid that the ASR engine 112 believes may have been uttered by the caller 102. The processing module 104 can use conventional methods to determine the candidate userid 124A that was actually uttered by the caller 102. This can be done either based entirely on the confidence scores in the speech recognition data element 160 output by the ASR engine 112, or by obtaining a confirmation from the caller 102.

Specifically, at flow E, the processing module 104 accesses the user profile database 120 on the basis of the candidate userid 124A. The user profile database 120 is searched for a particular one of the records 122 that is indexed by a userid that matches the candidate userid 124A provided by the processing module 104. Assuming that such a record can be found, the associated knowledge question (i.e., the selected knowledge question 134A) and the associated reference information element (i.e., the reference information element 126A) are returned to the processing module 104 at flow F.

Next, at flow I, the processing module 104 plays back or synthesizes the selected knowledge question 134A, to which the caller 102 responds with a second utterance 114B at flow J. If the caller 102 really is a legitimate user identified by the candidate userid 124A, then the second utterance 114B will represent a vocalized version of the reference information element 126A. On the other hand, if the caller 102 is not the user identified by the candidate userid 124A (e.g., if the caller 102 is an impostor), then the second utterance 114B will likely not represent a vocalized version of the reference information element 126A. It is the goal of the following steps to determine, on the basis of the second utterance 114B and other information, how likely it is that the reference information element 126A was conveyed in the second utterance 114B.

Accordingly, at flow K, the processing module 104 sends the utterance data element 150 (containing the second utterance 114B) and the grammar data element 155 to the ASR engine 112 for processing. At flow L, the ASR engine 112 returns the speech recognition data element 160 to the processing module 104. In a specific non-limiting embodiment, the speech data recognition data element 160 comprises a set of N speech recognition hypotheses with associated confidence scores. Each of the N speech recognition hypotheses represents a potential answer to the selected knowledge question 134A that the ASR engine 112 believes may have been uttered by the caller 102.

It is possible that one of the speech recognition hypotheses in the speech recognition data element 160 which has a high confidence score (e.g., above 0.5) corresponds to the reference information element 126A. This would indicate a high probability that the reference information element 126A is conveyed in the second utterance 114B. However, even where none of the speech recognition hypotheses in the speech recognition data element 160 that have a high confidence score (or regardless of confidence score) correspond to the reference information element 126A, this does not necessarily mean that the reference information element 126A was not conveyed in the second utterance 114B. The reason for this is that errors may have been committed by the ASR engine 112, which can arise due to the grammar used by the ASR engine 112 and/or the acoustic similarity between various sets of distinct letters or words. Accordingly, further processing is required to estimate the likelihood that the reference information element 126A is conveyed in the second utterance 114B.

To this end, at flow M, the processing module 104 sends the speech recognition data element 180 (containing the speech recognition data element 160 received from the ASR engine 112) as well as the correct answer information element 176 (containing the reference information element 126A accessed from the user profile database 120) to the score computation engine 128. The score computation engine 128 produces a score 190 indicative of an estimated likelihood that the reference information element 126A is conveyed in the second utterance 114B. Further detail regarding the operation of the score computation engine 128 will be provided later on.

At flow N, the score 190 is supplied to the processing module 104, which may compare the score 190 to a threshold in order to make a final accept/reject decision indicative of whether the caller 102 has or has not been successfully authenticated. If the caller 102 has been successfully authenticated as a legitimate user of the system 100, further interaction between the caller 102 and the processing module 104 and/or other processing entities may be permitted, thereby allowing the caller 102 to access a resource associated with the legitimate user, such as a bank account. If, on the other hand, the caller 102 has not been successfully authenticated as a legitimate user of the system 100, then various actions may be taken such as terminating the call, notifying the authorities, logging the attempt, allowing a retry, etc.

Score Computation Engine 128

With reference again to FIG. 1, the score computation engine 128 comprises a feature extractor 128B and a classifier 128C. The feature extractor 128B receives the speech recognition data element 160 and the reference information element 126A from the processing module 104. As will now be described, te feature extractor 128B is operative to (i) determine at least one similarity metric indicative of a degree of similarity between the speech recognition data element 160 and the reference information element 126A; and (ii) generate a feature vector 185 from the at least one similarity metric.

Firstly, assuming that the speech recognition data element 160 includes N speech recognition hypotheses and N≧1, a non-limiting way to compute the at least one similarity metric between the reference information element 126A and the speech recognition data element 160 is to perform a dynamic programming alignment between the letters/words in the reference information element 126A and those in each of the at least one speech recognition hypothesis, using, for example, letter/word insertion, deletion, and substitution costs computed as the logarithm of their respective probabilities of occurrence. The probabilities of occurrence are, in turn, dependent on the performance of the ASR engine 112, which can be measured or obtained as data from a third party. For instance, the ASR engine 112 may have a high probability of recognizing “J” when a “G” is spoken, but a low probability of recognizing “J” when “S” is spoken.

Thus, by performing a dynamic programming alignment between a speech recognition hypothesis in the speech recognition data element 160 and the reference information element 126A, one can compute an indication of the distance between them. In the above example, assuming that the reference information element 126A consists of the four letters “P A G E”, then the distance between “P A G E” and a first hypothesis “P A J E” would be less than the distance between “P A G E” and a second hypothesis “P A S E”.

It should be clear that when a particular speech recognition hypothesis (having a confidence score above a certain threshold) corresponds exactly to the reference information element 126A, then a similarity metric corresponding to a high degree of similarity will be produced. However, it is also possible that even if none of the speech recognition hypotheses correspond exactly to the reference information element 126A, a high score may nevertheless be produced where there is a strong likelihood that the differences between the reference information element 126A and at least one of the speech recognition hypotheses can be attributed to letter/word insertion, deletion and/or substitution having been caused by the ASR engine 112.

It should further be noted that other techniques for computing a similarity metric indicative of a degree of similarity between the speech recognition data element 160 and the reference information element 126A may be used. For example, in another non-limiting embodiment, a hidden Markov model (HMM) may be used. Other, distance-based metrics may also be used.

Secondly, it is recalled that the feature extractor 128B is further operative to generate the feature vector 185 from the at least one similarity metric. In a non-limiting example, where plural similarity metrics are computed, each indicative of a degree of similarity between a respective speech recognition hypothesis and the reference information element 126A, one of the vector elements produced by the feature extractor 128B may be representative of the one similarity metric that is indicative of the highest (i.e., maximum) degree of similarity. In another non-limiting example, another one of the vector elements may be representative of a combination of the similarity metrics, or an average similarity (which can be computed as the mean or median of the plural similarity metrics, for example). In yet another non-limiting example, another one of the vector elements may be representative of a similarity with respect to the first hypothesis in the speech recognition data element 160. The vector elements of the feature vector 185 may convey still other types of features derived from the similarity metric(s). It should also be appreciated that the confidence score of the various speech recognition hypotheses may be a factor in determining yet other vector elements of the feature vector 185 generated by the feature extractor 128B.

The feature vector 185, which comprises at least one but possibly more vector elements, is fed to the classifier 128C. The classifier 128C is operative to process the feature vector 185 in order to compute the score 190. As described below, the classifier 128C can be trained to tend to produce higher scores when processing training feature vectors derived from utterances known to convey respective reference information elements, and lower scores when processing training feature vectors derived from utterance known not to convey the respective reference information elements. Those skilled in the art will appreciate that one suitable but non-limiting implementation of the classifier 128C is in the form of a neural network.

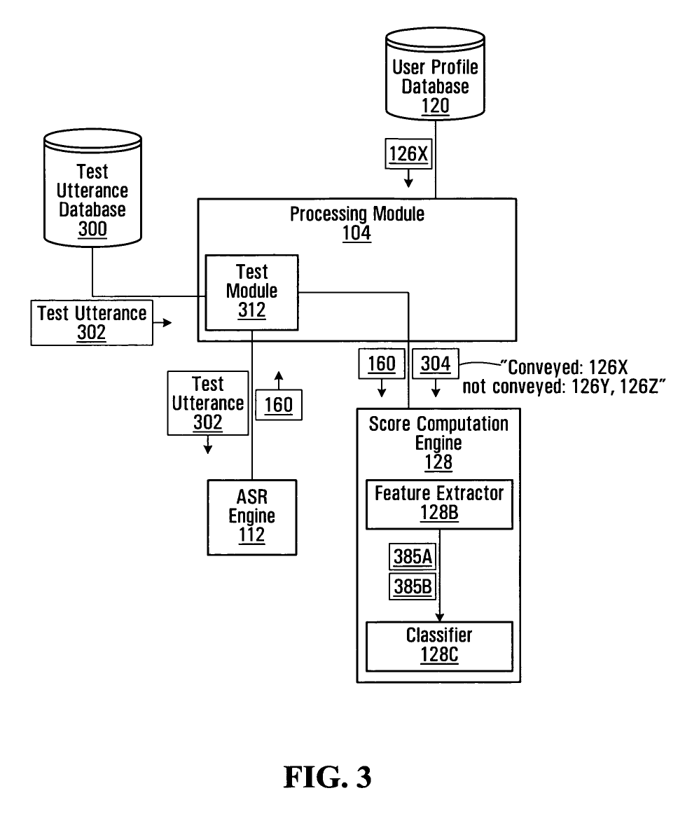

Training of the classifier 128C is now described in greater detail with reference to FIG. 3. Specifically, the system 100 undergoes a training phase, during which the system 100 is experimentally tested across a wide range of “test utterances” from a test utterance database 300 accessible to a test module 312 in the processing module 104.

A first test utterance in the test utterance database 300 may convey a first reference information element 126X while not conveying a second reference information element 126Y or a third reference information element 126Z. Similarly, a second test utterance in the test utterance database 300 may convey the second reference information element 126Y while not conveying reference information elements 126X and 126Z.

With the knowledge of whether a given test utterance does or does not convey a given reference information element, one can adaptively modify the behavior of the classifier 128C in such a way that the score 190 is a statistically reliable indication of whether an eventual utterance does or does not convey the respective reference information element.

Specifically, an iterative training process may be employed, starting with a test utterance 302 that is retrieved by the test module 312 from the test utterance database 300. Assume for the moment that the test utterance 302 is known to convey the reference information element 126X and is known not to convey the reference information elements 126Y and 126Z. The test utterance database 300 has knowledge of which reference information element is conveyed by the test utterance 302 and which reference information elements are not. This knowledge is provided to the test module 312 and forwarded to the score computation engine 128 in the form of a data element 304.

Meanwhile, the test utterance 302 is sent to the ASR engine 112 for speech recognition. As already described, the ASR engine 112 returns the speech recognition data element 160 comprising N speech recognition hypotheses, which are simply forwarded by the processing module 104 to the score computation engine 128.

In continuing accordance with the training phase, the feature extractor 128B in the score computation engine 128 produces a plurality of feature vectors for the test utterance 302, one of which is hereinafter referred to as a “correct” training feature vector and denoted 385A, with the other feature vector(s) being hereinafter referred to as “incorrect” training feature vector(s) and denoted 385B. The manner in which the correct training feature vector 385A and the incorrect training feature vector(s) 385B are produced is described below.

Firstly, having regard to formation of the correct training feature vector 385A, the feature extractor 128B determines at least one similarity metric from the reference information element 126X (known to be conveyed in the test utterance 302 due to the availability of the data element 304) and the speech recognition data element 160 provided by the ASR engine 112. The feature extractor 128B then proceeds to extract specially selected features (e.g., average similarity, highest similarity, etc.) from the at least one similarity metric in order to form the correct training feature vector 385A.

Having regard to formation of the at least one incorrect training feature vector 385B, the feature extractor 128B determines at least one similarity metric on the basis of a reference information element known not to be conveyed in the test utterance 302 (such as the second or third reference information elements 126Y, 126Z) and the speech recognition data element 160 provided by the ASR engine 112. The feature extractor 128B then proceeds to extract specially selected features from this at least one similarity metric in order to form an incorrect training feature vector 385B. The same may also be done on the basis of another reference information element known not to be conveyed in the test utterance 302, thus resulting in the creation of additional incorrect training feature vectors 385B.

The foregoing is performed for a number of additional test utterances until a collection of correct training feature vectors 385A and incorrect training feature vectors 385B is assembled.

The classifier 128C then executes a computational process for producing an interim score from each of the correct and incorrect training feature vectors. For example, the classifier 128C may implement a base algorithm that computes a neural network output from its inputs and a set of parameters, in addition to a tuning algorithm that allows the set of parameters to be tuned on the basis of an error signal. Advantageously, the classifier 128C will be trained to produce a high score for the correct training feature vectors 385A and a low score for the incorrect training feature vectors 385B. As an example, this can be achieved using an adaptive process, whereby an error signal is computed based on the difference between the score actually produced and the score that should have been produced. This error signal can then be fed to the tuning algorithm implemented by the classifier 128C, thus allowing the parameters used by the base algorithm to be adaptively tuned.

It should thus be appreciated that by adaptively tuning the parameters used by the base algorithm implemented by the classifier 128C, one will have the scenario that when the second utterance 114B is eventually received from the caller 102 in an operational scenario, the ensuing decision (i.e., the score 190) will tend to correctly reflect whether the second utterance 114B conveys or does not convey the reference information element 126A.

The degree of correctness of the decision as a function of what the decision should have been can be measured as a false-acceptance/false-rejection (FA/FR) curve over a variety of utterances. Specifically, the FA rate is computed over all utterances that do not convey the reference information element 126A while the FR rate is computed over utterances that do. The curve is obtained by varying the value of the acceptance threshold (i.e., the score considered to be sufficient to declare acceptance), which changes the values of FA and FR (each threshold value produces a pair of FA and FR values).

It is noted that in addition to adaptively tuning the parameters used by the base algorithm implemented by the classifier 128C, it is also possible to adjust the types of features that are extracted by the feature extractor 128B, so as to converge to a set of features which, when extracted and when subsequently processed by the classifier 128C, lead to an increased likelihood of producing a high score when an eventual utterance does convey the respective information element and a low score when it does not.

Moreover, it is also possible to adaptively adjust the grammar used by the ASR engine 112. This may to further increase the likelihood with which the score 190 output by the classifier 128C correctly reflects conveyance or non-conveyance of the respective reference information element in an eventual utterance received during an operational scenario.

Dynamic Grammar

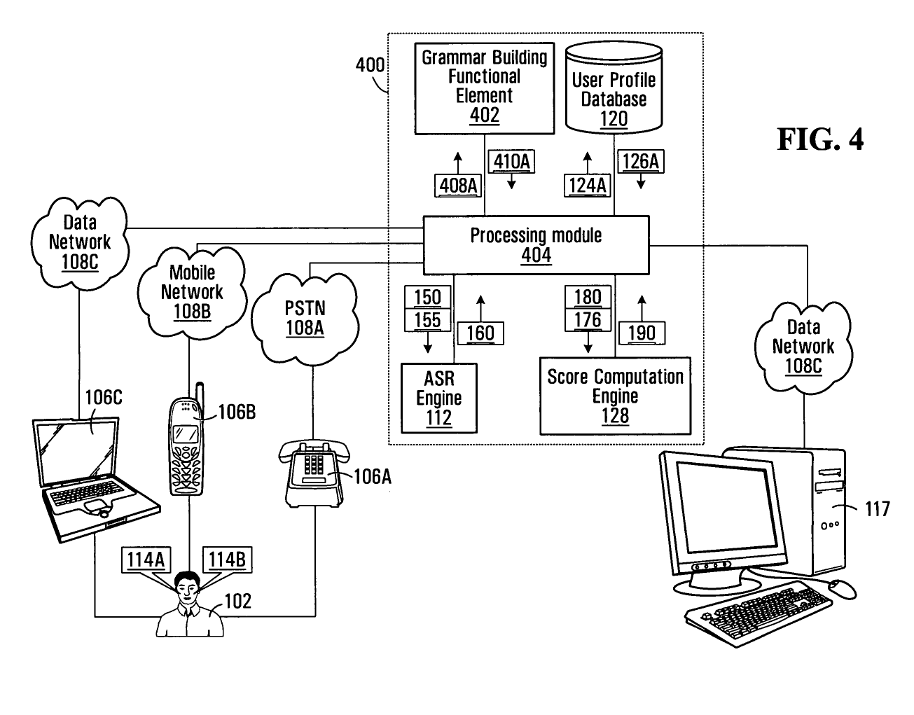

In order to achieve even greater performance, the grammar used by the ASR engine 112 can be dynamic, i.e., it can be made dependent on the reference information element 126A. To this end, FIG. 4 shows an ASR-based authentication system 400, which differs from the system 100 in FIG. 1 in that it comprises a grammar building functional element 402 that interfaces with a modified processing module 404. The processing module 404 is identical to the processing module 104 except that it additionally comprises suitable circuitry, software and/or control logic for providing the grammar building functional element 402 with a candidate data element 408A, and receives a dynamically built grammar 410A from the grammar building functional element 402.

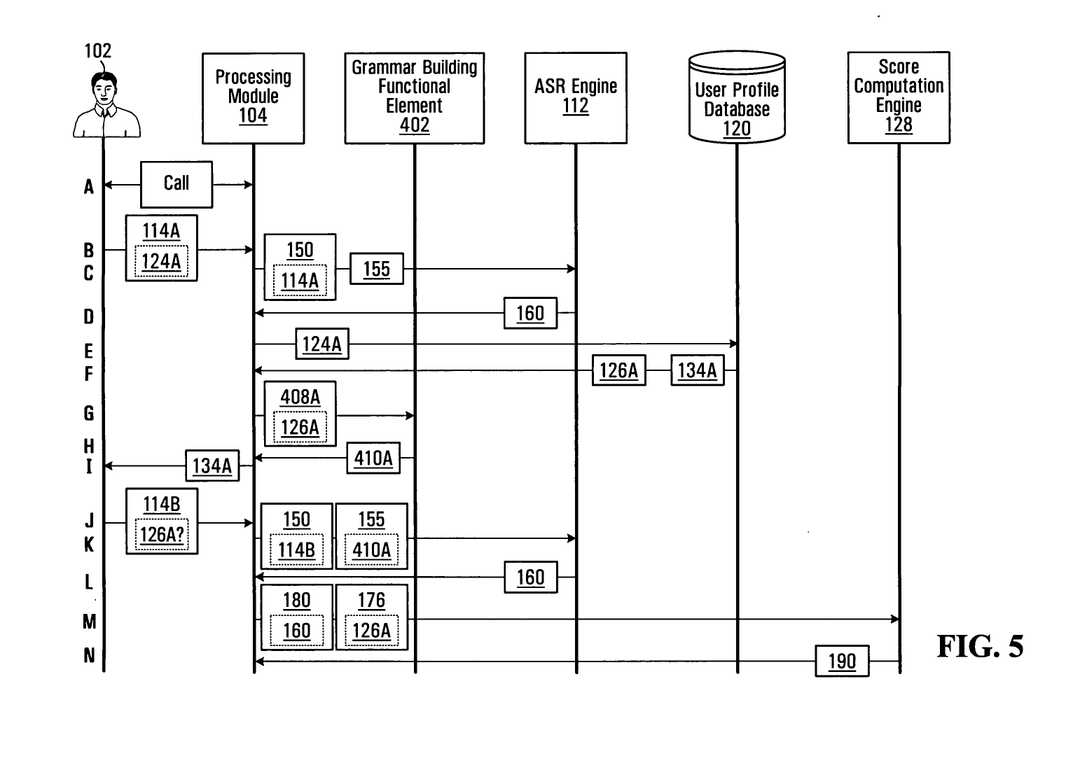

Operation of the system 400 is now described with reference to FIG. 5, which is identical to FIG. 2 except that it additionally comprises a flow G, where the processing module 404 provides the grammar building functional element 402 with the candidate data element 408A. In a specific non-limiting embodiment, the candidate data element 408A may be the reference information element 126A that was returned from the user profile database 120 at flow F.

The grammar building functional element 402 is operable to dynamically build a grammar 410A on the basis of the candidate data element 408A, which is in this case the reference information element 126A. In one specific non-limiting example, the grammar building functional element 402 implements a grammar building process in that uses a fixed grammar component (which does not depend on the reference information element 126A) and a variable grammar component. The variable grammar component is built on the basis of the reference information element 126A. Further details regarding the manner in which grammars can be built dynamically are assumed to be within the purview of those skilled in the art and therefore such details are omitted here for simplicity. In an alternative embodiment, the grammar building functional element 402 comprises a database of grammars from which one grammar is selected on the basis of the reference information element 126A. Regardless of the implementation of the grammar building functional element 402, the dynamically built grammar 410A is returned to the processing module 404 at flow H.

Flows I and J are identical to those previously described with reference to FIG. 2. Flow K is also similar in that the processing module 404 sends the second utterance 114B to the ASR engine 112 for processing, along with the grammar data element 155; however, in this embodiment, the grammar data element 155 contains the dynamically built grammar 410A that was received from the grammar building functional element 402 at flow H above.

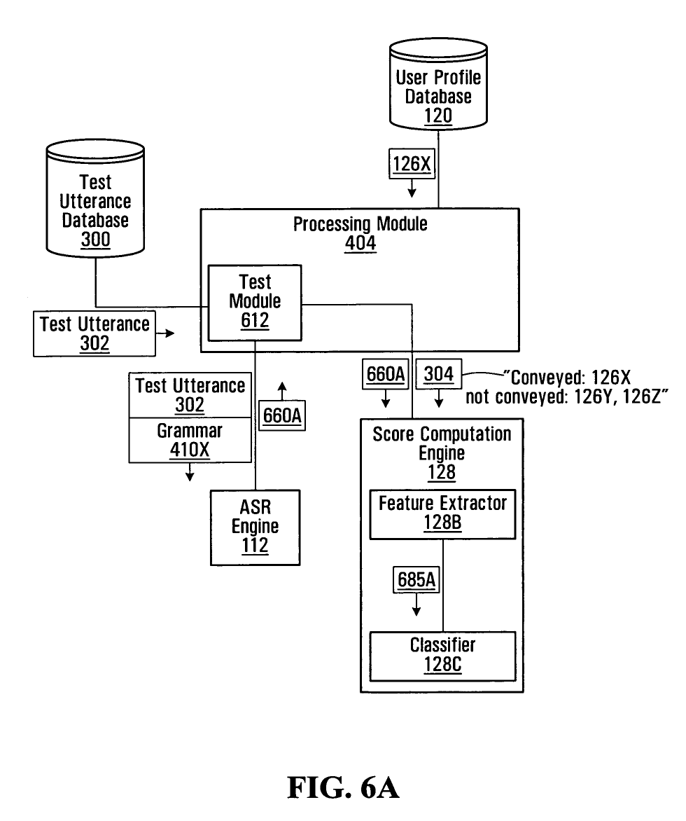

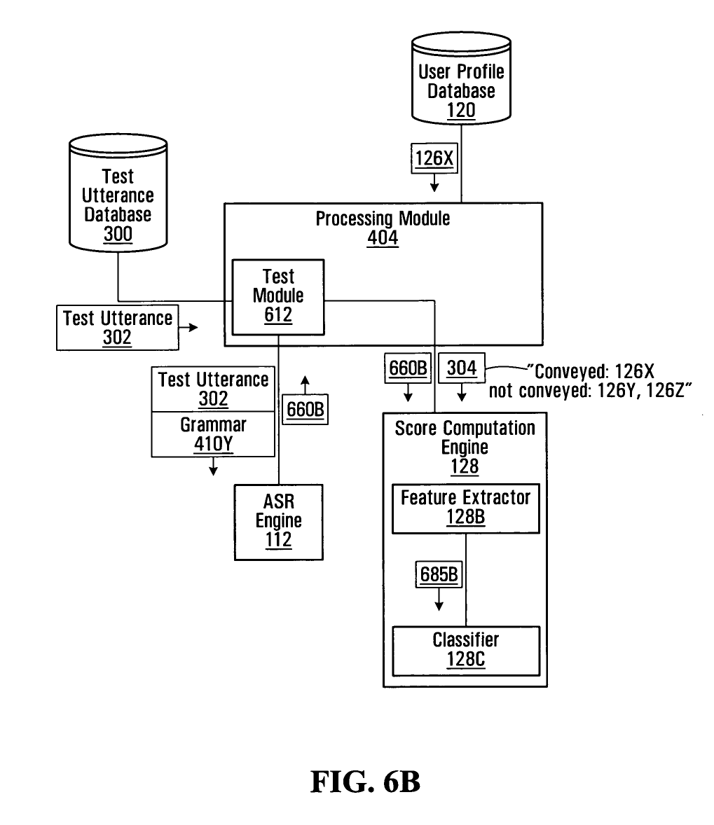

It should be noted that where a dynamic grammar is used as described above, the system may benefit from a more complex training phase than for the case where a common grammar is used. Accordingly, a suitable non-limiting example of a complex training phase for the system 400 is now described in greater detail with reference to FIGS. 6A and 6B. During the complex training phase, the system 400 is experimentally tested across a wide range of “test utterances” from the previously described test utterance database 300, which is accessible to a test module 612 in the processing module 404.

As before, an iterative training process may be employed, starting with a test utterance 302 that is retrieved by the test module 612 from the test utterance database 300. Assume again that the test utterance 302 is known to convey the reference information element 126X and is known not to convey the reference information elements 126Y and 126Z. The test utterance database 300 has knowledge of which reference information element is conveyed by the test utterance 302 and which reference information elements are not. This knowledge is provided to the test module 612 and forwarded to the score computation engine 128 in the form of a data element 304.

Meanwhile, the test utterance 302 is sent to the ASR engine 112 for speech recognition. This is done in two stages, hereinafter referred to as a “correct” stage and an “incorrect stage”. In the “correct” stage, shown in FIG. 6A, the test module 612 provides the ASR engine 112 with the grammar (denoted 410X) that is associated with the first reference information element 126X. For example, the grammar 410X can be obtained in response to supplying the grammar building functional element 402 with the first reference information element 126X. The ASR engine 112 returns a speech recognition data element, hereinafter referred to as a “correct” speech recognition data element 660A, comprising N speech recognition hypotheses, which are forwarded by the processing module 404 to the score computation engine 128.

In the “incorrect” stage, the test module 612 provides the ASR engine 112 with a grammar (denoted 410Y) different from grammar 410X that was associated with the first reference information element 126X. The ASR engine 112 returns a speech recognition data element, hereinafter referred to as an “incorrect” speech recognition data element 660B, comprising N speech recognition hypotheses, which are forwarded by the processing module 104 to the score computation engine 128. This may be repeated for additional differing grammars, resulting in potentially more than one “incorrect” speech recognition data element 660B being produced for the test utterance 302.

In continuing accordance with the training phase, the feature extractor 128B in the score computation engine 128 produces a plurality of feature vectors for the test utterance 302, one of which one is hereinafter referred to as a “correct” training feature vector and denoted 685A, with the other feature vector(s) being hereinafter referred to as “incorrect” training feature vector(s) and denoted 685B. The manner in which the correct training feature vector 685A and the incorrect training feature vector(s) 685B are produced is described below.

Firstly, having regard to formation of the correct training feature vector, the feature extractor 128B determines at least one similarity metric on the basis of the first reference information element 126X (known to be conveyed in the test utterance 302 due to the availability of the data element 304) and the correct speech recognition data element 660A provided by the ASR engine 112. The feature extractor 128B then proceeds to extract specially selected features from this at least one similarity metric, thereby to form a correct training feature vector.

Having regard to formation of the at least one incorrect training feature vector 685B, the feature extractor 128B determines at least one similarity metric on the basis of a reference information element known not to be conveyed in the test utterance 302 (such as the second or third reference information element 126Y, 126Z) and the incorrect speech recognition data element 660B provided by the ASR engine 112. The feature extractor 128B then proceeds to extract specially selected features from this at least one similarity metric in order to form an incorrect training feature vector 685B. The same may also be done on the basis of another reference information known to not be conveyed in the test utterance 302, thus resulting in the creation of additional incorrect training feature vectors 685B.

The foregoing is performed for a number of additional test utterances until a collection of correct training feature vectors 685A and incorrect training feature vectors 685B is assembled.

The classifier 128C then executes a computational process for producing an interim score from each of the correct and incorrect training feature vectors. For example, the classifier 128C may implement a base algorithm that computes a neural network output from its inputs and a set of parameters, in addition to a tuning algorithm that allows the set of parameters to be tuned on the basis of an error signal. Advantageously, the classifier 128C will be trained to produce a high score for the correct training feature vectors 685A and a low score for the incorrect training feature vectors 685B. As an example, this can be achieved using an adaptive process, whereby an error signal is computed based on the difference between the score actually produced and the score that should have been produced. This error signal can then be fed to the tuning algorithm implemented by the classifier 128C, thus allowing the parameters used by the base algorithm to be adaptively tuned.

It should thus be appreciated that by adaptively tuning the parameters used by the base algorithm implemented by the classifier 128C, one will have the scenario that when the second utterance 114B is eventually received from the caller 102 in an operational scenario, the ensuing decision (i.e., the score 190) will tend to correctly reflect whether the second utterance 114B conveys or does not convey the reference information element 126A. The degree of correctness of the decision as a function of what the decision should have been can be measured as a false-acceptance/false-rejection (FA/FR) curve, as described previously.

It is noted that in addition to adaptively tuning the parameters used by the base algorithm implemented by the classifier 128C, it is also possible to adjust the types of features that are extracted by the feature extractor 128B, so as to converge to a set of features which, when extracted and when subsequently processed by the classifier 128C, lead to an increased likelihood of producing a high score when an eventual utterance does convey the respective information element and a low score when it does not.

Moreover, those skilled in the art will appreciate that it is also within the scope of the invention to use a feedback process in order to adjust the fixed grammar component used by the grammar building process implemented in the grammar building functional element 402. This may to further increase the likelihood with which the score output by the classifier 128C correctly reflects conveyance or non-conveyance of the respective reference information element in an eventual utterance during an operational scenario.

Further Variants

The above embodiments have considered the case where the answer to a single knowledge question is used by the processing module 104 to make a final accept/reject decision. However, it should be understood that it is within the scope of the present invention to ask the caller 102 to supply answers to a plurality of knowledge questions. Furthermore, the number of knowledge questions to be answered by the caller 102 may be fixed by the processing module 104. Alternatively, the number of knowledge questions to be answered by the caller 102 may depend on the score supplied by the score computation engine 128 for each preceding knowledge question. Still alternatively, the number of knowledge questions to be answered by the caller 102 may depend on the candidate userid 124A keyed in or uttered by the caller 102. It is recalled that the candidate userid 124A may take the form of a name or number associated with a legitimate user of the system 100.

In addition, where plural knowledge questions have generated corresponding answers with associated scores, the final accept/reject decision by the processing unit 104 may be based on the requirement that the score associated with the answer corresponding to each (or M out of N) of the knowledge questions be above a pre-determined threshold, which threshold can be individually defined for each knowledge question.

It is also within the scope of the present invention to defer the decision to proceed with a subsequent knowledge question until the caller 102 has been given an opportunity to spell (e.g., alphabetically or alphanumerically) his or her answer to a particular knowledge question that has generated a low score. For example, the dialog with the system 100, 400 might be:
System 100, 400: “Please say your mother's maiden name”
Caller 102: “Smyth”
System 100, 400: “Please spell say your mother's maiden name”
Caller 102: “S” “M” “Y” “T” “H”

The above technique may be particularly useful in eliminating false rejections where the reference information element 126A—although possibly reasonable in length—is nevertheless subject to a varied range of pronunciations, as may be the case with names, places or made-up passwords. Such use of spelling as a “back-up” for unusual words appears natural to the user while offering the advantage, from a speech recognition standpoint, of being much less sensitive to the speaker's accent or the origin of the word.

Those skilled in the art will appreciate that the authentication process described herein can also be combined with other authentication processes, for instance biometric speaker recognition technology using voiceprints, as well as technologies that employ other information to help authenticate a user, such as knowledge of the fact that the caller 102 is calling from his home phone.

The functionality of all or part of the processing unit 104, 404 and/or score computation engine 128 may be implemented as pre-programmed hardware or firmware elements (e.g., application specific integrated circuits (ASICs), electrically erasable programmable read-only memories (EEPROMs), etc.), or other related components. In other embodiments, all or part of the processing unit 104, 404 and/or score computation engine 128 may be implemented as an arithmetic and logic unit (ALU) having access to a code memory (not shown) which stores program instructions for the operation of the ALU. The program instructions could be stored on a medium which is fixed, tangible and readable directly by the processing unit 104, 404 and/or score computation engine 128, (e.g., removable diskette, CD-ROM, ROM, fixed disk, USB drive), or the program instructions could be stored remotely but transmittable to the processing unit 104, 404 and/or score computation engine 128 via a modem or other interface device.

While specific embodiments of the present invention have been described and illustrated, it will be apparent to those skilled in the art that numerous modifications and variations can be made without departing from the scope of the invention as defined in the appended claims.

1. A method, comprising:
receiving a speech recognition result derived from ASR processing of a received utterance;
obtaining a reference information element for said utterance;
determining at least one similarity metric indicative of a degree of similarity between said speech recognition result and said reference information element;
determining a score based on said at least one similarity metric;
outputting a data element indicative of said score.

2. The method defined in claim 1, wherein said determining a score comprises:
determining a feature vector from said at least one similarity metric, said feature vector comprising at least one vector element, and
computing said score based from said at least one feature-vector element.

3. The method defined in claim 2, wherein said feature vector comprises a plurality of vector elements.

4. The method defined in claim 3, wherein computing said score comprises processing the plurality of vector elements by a classifier.

5. The method defined in claim 4, said classifier having been trained to tend to produce higher scores when processing training feature vectors derived from utterances known to convey associated reference information elements than when processing training feature vectors derived from utterances known not to convey said associated reference information elements.

6. The method defined in claim 5, wherein said classifier is implemented as a neural network.

7. The method defined in claim 5, wherein said degree of similarity is a function of at least one of a letter insertion cost, a letter deletion cost, a letter substitution cost, a word insertion cost, a word deletion cost and a word substitution cost.

8. The method defined in claim 5, wherein said speech recognition result includes at least one speech recognition hypothesis, wherein said degree of similarity is obtained by performing a dynamic programming alignment between said at least one speech recognition hypothesis and said reference information element.

9. The method defined in claim 5, wherein said speech recognition result includes a plurality of speech recognition hypotheses, wherein said at least one similarity metric comprises a plurality of similarity metrics, each of said plurality of similarity metrics being indicative of a degree of similarity between a respective one of said plurality of speech recognition hypotheses and said reference information element.

10. The method defined in claim 9, wherein at least one of said vector elements is representative of the one of said plurality of similarity metrics that is indicative of the highest degree of similarity.

11. The method defined in claim 9, wherein at least one of said vector elements is representative of an average of said plurality of similarity metrics.

12. The method defined in claim 5, wherein said speech recognition result includes at least one speech recognition hypothesis and further includes, for each of said at least one speech recognition hypothesis, a confidence score associated with the respective speech recognition hypothesis

13. The method defined in claim 12, wherein at least one of said vector elements is determined on a basis of the confidence score associated with each of said at least one speech recognition hypothesis.

14. The method defined in claim 1, further comprising, prior to said receiving said speech recognition result, the step of receiving an identity claim, wherein said obtaining a reference information element for said utterance comprises accessing from a database a record containing a second information element matching the identity claim.

15. The method defined in claim 5, further comprising, prior to said receiving said speech recognition result, the step of receiving an identity claim, wherein said obtaining a reference information element for said utterance comprises accessing from a database a record containing a second information element matching the identity claim.

16. The method defined in claim 15, further comprising:
responsive to said score exceeding a threshold, successfully authenticating the party as having the claimed identity.

17. The method defined in claim 1, further comprising prompting the party to make said utterance.

18. The method defined in claim 17, wherein prompting the party to make said utterance comprises asking the party to respond to a knowledge question.

19. The method defined in claim 18, wherein said knowledge question is associated with a legitimate user having the claimed identity.

20. The method defined in claim 19, further comprising obtaining said knowledge question by accessing a record associated with said legitimate user.

21. The method defined in claim 1, further comprising:
responsive to said score exceeding a threshold, declaring the received utterance as conveying the reference information element.

22. The method defined in claim 21, further comprising:
responsive to said score not exceeding said threshold, declaring the received utterance as not conveying the reference information element.

23. The method defined in claim 1, wherein said at least one speech recognition hypothesis is received from an ASR engine, the method further comprising, prior to said receiving at least one speech recognition hypothesis, the step of providing to the ASR engine a grammar for ASR processing of the utterance received from the party.

24. The method defined in claim 23, further comprising dynamically building said grammar.

25. The method defined in claim 24, wherein dynamically building said grammar is effected on a basis of the reference information element.

26. The method defined in claim 5, further comprising training said classifier.

27. The method defined in claim 26, wherein training said classifier comprises:
providing a plurality of test utterances;
for each test utterance, providing a correct training feature vector and at least one incorrect training feature vector, thereby to create a collection of correct training feature vectors and a collection of incorrect training feature vectors, the correct training feature vector derived from a test utterance known to convey an associated reference information element, the at least one incorrect training feature vector derived from a test utterance known not to convey said associated reference information element;
processing the collection of correct training feature vectors and the collection of incorrect training feature vectors by said classifier while adjusting at least one performance parameter of said classifier and monitoring the score produced by said classifier;
wherein said adjusting is performed to maximize the probability that the score produced by the classifier is greater for the correct training feature vectors in the collection of correct training feature vectors than for the incorrect training feature vectors in the collection of incorrect training feature vectors.

28. The method defined in claim 27, wherein each of said correct training feature vectors is derived from at least one similarity metric computed between (i) an output of ASR processing of the particular test utterance and (ii) said particular reference information element.

29. The method defined in claim 28, wherein each of said incorrect training feature vectors is derived from at least one similarity metric computed between (ii) an output of ASR processing of the particular test utterance and (ii) a reference information element different from said particular reference information element.

30. The method defined in claim 28, wherein said output of ASR processing is derived from ASR processing of said particular test utterance with respect to a grammar that is associated with said particular reference information element.

31. The method defined in claim 30, wherein each of said incorrect training feature vectors is derived from at least one similarity metric computed between (ii) a second output of ASR processing of the particular test utterance and (ii) a reference information element different from said particular reference information element.

32. The method defined in claim 31, wherein said output of ASR processing is derived from ASR processing of said particular test utterance with respect to a grammar that is not associated with said particular reference information element.

33. The method defined in claim 32, further comprising adjusting at least one parameter of said grammar that is associated with said particular reference information element, wherein said adjusting is performed to maximize the probability that the score produced by the classifier is greater for the correct training feature vectors in the collection of correct training feature vectors than for the incorrect training feature vectors in the collection of incorrect training feature vectors.

34. A score computation engine for use in user authentication, comprising:
a feature extractor operable to determine at least one similarity metric indicative of a degree of similarity between (i) a speech recognition result derived from ASR processing of a received utterance; and (ii) a reference information element for said utterance; and
a classifier operable to determine a score based on said at least one similarity metric and to output a data element indicative of said score.

35. The score computation engine defined in claim 34, wherein said classifier being operable to determine a score comprises said classifier being operable to compute said score from a plurality of feature vector elements of a feature vector determined from said at least one similarity metric.

36. The method defined in claim 35, said classifier having been trained to tend to produce higher scores when processing training feature vectors derived from utterances known to convey associated reference information elements than when processing training feature vectors derived from utterances known not to convey said associated reference information elements.

37. An authentication method, comprising:
receiving from a party a purported identity of a user, the user being associated with a knowledge question and a corresponding stored response to said knowledge question;
providing to the caller an opportunity to respond to said knowledge question associated with the user;
receiving from the caller a first utterance responsive to said providing, said first utterance corresponding to said knowledge question associated with the user;
providing to the caller a second opportunity to respond to said knowledge question associated with the user;
receiving from the caller a plurality of second utterances responsive to said providing, each of said plurality of second utterances corresponding to an alphanumeric character corresponding to said knowledge question associated with the user;
determining a score indicative of a similarity between said plurality of second utterances and the stored response to the knowledge question associated with the user;
declaring the party as either authenticated or not authenticated on the basis of said score.

38. The authentication method defined in claim 37, further comprising:
determining an initial score indicative of a similarity between said first utterance and the stored response to the knowledge question associated with the user;
attempting to authenticate the party on the basis of said initial score;
proceeding with providing to the caller said second opportunity only if said attempting to authenticate is unsuccessful.
